(19) United States
(12) Patent Application Publication
(10) Pub. No.: US 2018/0175467 A1
(43) Pub. Date: Jun. 21, 2018

(54) HEAT DISTRIBUTOR FOR A BATTERY

(71) Applicant: Robert Bosch GmbH, Stuttgart (DE)

(72) Inventors: Christian Schmid-Schoenbein, Stuttgart (DE); Philipp Stawarz, Untergruppenbach (DE)

(21) Appl. No.: 15/837,337

(22) Filed: Dec. 11, 2017

(30) Foreign Application Priority Data
Dec. 15, 2016 (DE) 10 2016 225 192.9

(51) Int. Cl. H01M 10/651; H01M 10/0525; H01M 2/10; H01M 10/658; H01M 10/6552; H01M 10/625; H01M 10/613

(52) U.S. Cl. CPC H01M 10/651; H01M 10/0525; H01M 2/1077; H01M 2220/20; H01M 10/6552; H01M 10/625; H01M 10/613; H01M 10/658

(57) ABSTRACT

A battery (100), in particular a lithium ion battery, having at least two battery cells (10a-t) and having at least one anisotropic heat distributor (24) is described, the at least two battery cells (10a-t) are arranged adjacent to one another in a plane on the same side of the anisotropic heat distributor (24), in direct thermally conductive contact therewith.

### BACKGROUND OF THE INVENTION

The present invention relates to a battery, in particular a lithium ion battery, having at least two battery cells and having at least one anisotropic heat distributor, and to the use thereof.

A battery cell is an electrochemical energy storage device which, as it discharges, converts the stored chemical energy into electrical energy through an electrochemical reaction. It is apparent that in the future new battery systems, of which very high demands in terms of reliability, safety, efficiency and service life will be made, will be used both in the stationary applications such as wind turbines, in motor vehicles which are configured as hybrid motor vehicles or electric motor vehicles, as well as also in electronic devices. Owing to their high energy density, in particular lithium ion batteries are used as energy storage devices for electrically powered motor vehicles.

US2013/0323564 discloses a battery pack with a multiplicity of prismatic battery cells which are stacked one on top of the other. In each case a heat distributor composed of graphite is arranged between adjacent battery cells in the battery stack. The heat distributor has two main surfaces, wherein the main surfaces are in contact with a cooling plate.

DE102014004764 discloses a heat exchanger which comprises a heat conductor plate which contains an anisotropically thermally conductive material whose thermal conductivity is higher parallel to a main surface of the heat conductor plate than perpendicularly with respect to the main surface. Furthermore, the heat exchanger has a duct for a heat transfer fluid, wherein the distance between a transmission edge of the thermal conductor plate and the duct is less than the thickness of the thermal conductor plate.

US 2013/0273413 discloses a battery having a multiplicity of cells which are arranged on a plate. In the operationally ready state, the battery assumes an asymmetrical shape, as a result of which available space within a portable electronic device can be utilized.

WO 2014/038891 has a secondary battery with a multiplicity of electrode assemblies which are inserted into recesses in a coherent casing. The casing is then respectively divided between the electrode assemblies, with the result that the electrode assemblies are present separately from one another in their recesses.

### SUMMARY OF THE INVENTION

According to the invention, a battery, in particular a lithium ion battery, and a vehicle comprising the battery are provided with the features of the independent claims.

In comparison with isotropic heat distributors, which conduct heat independently of direction, anisotropic heat distributors conduct heat in a direction-dependent fashion, and therefore with different degrees of effectiveness in different directions. Within the sense of this invention, the anisotropic heat distributor conducts heat very well in the plane, for example with thermal conductivity of 250 W/mK up to 10 000 W/mK, and with a significantly lower thermal conductivity, for example of 5 W/mK to 200 W/mK perpendicularly with respect to the plane. Therefore, heat is conducted very efficiently by the heat distributor in the plane, while heat is conducted less strongly perpendicularly with respect to the plane.

The term thermal runaway of a battery cell means that a battery cell reacts exothermally owing to a defect and generates so much heat that it overheats. This generally results in the battery becoming unusable. The heat which is generated by the battery cell which is experiencing thermal runaway is conducted to adjacent battery cells which then also go into an exothermal state and become unusable as a result of overheating. This process follows a chain reaction and is virtually unstoppable with the frequent consequence of a fire and/or an explosion. For this reason, this case must absolutely be avoided.

The battery according to the invention has at least two battery cells and at least one anisotropic heat distributor, wherein the at least two battery cells are arranged adjacent to one another in a plane on the same side of the anisotropic heat distributor, in direct thermally conductive contact therewith. It is advantageous here that in the case of a runaway of a battery cell the heat which is produced by this faulty battery cell is conducted away very efficiently from the faulty battery cell via the heat distributor. As a result of the very good thermal conduction in the plane, the heat is in this way conducted to the at least one adjacent battery cell and advantageously to a large number of battery cells which are in thermally conductive contact with the heat distributor. As a result of the conduction of the heat away from the defective battery cell, the overheating thereof is at least delayed, which provides more time, for example, for further safety mechanisms to intervene. As a result of the conduction of the heat to a large number of battery cells which are in contact with the heat distributor, the battery cells which are located directly next to the faulty battery cell overheat less quickly, since the heat is conducted not only to these battery cells but also to other battery cells lying further away. In this way, it is not the case that a few battery cells heat up to a great extent but instead a large number of battery cells heat up to a certain extent. The fact that the at least two battery cells are arranged adjacent to one another on the same side of the anisotropic heat distributor in the present invention is a decisive advantage over battery cells which are stacked one on top of the other. Stacked battery cells do not have any battery cells which are directly adjacent to them, as a result of which the heat in the plane cannot be distributed to other battery cells through a heat distributor.

In a normal operating state without a fault situation, the anisotropic heat distributor assists the dissipation of heat from the battery cells to a cooling plate. This means that the heat is generally apportioned between the battery cells which are arranged one next to the other and connected in a thermally conductive fashion to the anisotropic heat distributor, and the dissipation of the heat to the cooling plate then takes place either via the anisotropic heat distributor or via the battery cells.

Further advantageous embodiments of the present battery and of the battery cell system can be found in the dependent claims.

In one embodiment, the anisotropic heat distributor is a graphite film. The carbon atoms are arranged in a hexagonal layered structure in the graphite. Within these so-called basal levels or graphite layers there is an extremely strong covalent bond between the carbon atoms. The layers which are arranged in parallel are, on the other hand, only very weakly bound to one another. This gives rise to very strong anisotropy of the electrical and thermal conductivity.

The thermal conductivity within the basal layers is 10³ to 10⁴ W/km, and the thermal conductivity between the basal layers, that is to say the thermal conductivity perpendicularly with respect to the respective basal layers is, for example 10¹ to 10² W/km.

In an alternative embodiment the heat distributor is a heat pipe.

In one advantageous embodiment, a thermal insulator is introduced between the adjoining cell housing faces of adjacent battery cells, which thermal insulator prevents a transfer of heat between the adjoining cell housing faces of the adjacent battery cells. Therefore, in the case of a battery cell which heats up exothermally, the heat which is produced during normal operation or in the case of a fault cannot be conducted directly to an adjacent battery cell but rather only to adjacent battery cells via the heat distributor. It is advantageous here that the adjacent battery cells heat up less strongly, since the heat distributor distributes the thermal energy to a large number of battery cells and not only to the directly adjacent battery cells. As a result, the battery cells which are located next to a battery cell which heats up strongly are protected against rapid excessively strong heating and therefore in an optimum case against thermal runaway. This protects the components of the battery cell, which are therefore not subjected to excessively high temperatures, and extends the service life of the battery, and also its safety.

In a further embodiment, the thermal insulator is embodied as a film. It is advantageous here that a film is flexible and can therefore adapt to movements of the battery without being damaged. Such movements occur, for example, in the case of vibrations as a result of traveling on uneven roads when a battery is located in a vehicle. An insulator which is embodied as a film remains in contact with the battery cells which are arranged thereon, since the film can fit snugly against the battery cells. In addition, there is, for example, no air gap which can have a thermally insulating effect.

In a further advantageous embodiment, the material of the thermal insulator comprises a polyurethane, a polystyrene, expanded perlite, a cellular glass, calcium silicate, mica, mineral wool, a mineral paper and/or mineral fibers which can act as a flame barrier and can prevent propagation of a fire.

In one embodiment, the thermal insulator is adhered to the battery cells by means of an adhesive. Alternatively, the thermal insulator and the battery cells are clamped to one another when assembly occurs.

In a further embodiment, the thermal insulator has a thickness of 1-10 mm, in particular of 3-5 mm. It is advantageous here that with this thickness the insulation effect is so strong that adjacent battery cells of a battery cell which heats up do not run away thermally either, since the electrolyte of the adjacent battery cells remains below a critical temperature.

In one particularly advantageous embodiment the battery has at least one battery cell system comprising a pouch film with at least two pockets and at least two electrode assemblies. The electrode assemblies are introduced into the separate pockets of the pouch film, with the result that in each case one electrode assembly together with a pocket of the pouch film forms one battery cell, wherein the battery cells are physically connected to one another in a foldable fashion by means of the pouch film.

The term pouch film is to be understood within the scope of this invention as a flexible film, in particular a composite film, which is impermeable to an electrolyte. The pouch film comprises, for example, a laminate. The laminate comprises, for example, aluminum. Alternatively, the laminate does not comprise any aluminum, in particular does not comprise any metal.

The term electrode assembly is to be understood as meaning an assembly comprising at least one anode and at least one cathode in which lithium ions can be reversibly accumulated and released again.

During the charging of lithium ion cells, lithium ions migrate from the cathode to the anode through the electrolytes and are accumulated therein. At the same time, electrons also migrate from the cathode to the anode via an external circuit. During the discharging of lithium ion cells, these processes take place in the reverse direction so that lithium ions migrate from the anode to the cathode and are accumulated therein.

Furthermore, the electrode assembly comprises at least one separator which separates the anode and the cathode both spatially and electrically and comprises, for example, a polyolefin. The anode, the separator and the cathode can be wound one into the other or be present stacked one on top of the other.

An advantage with a battery according to the invention with the battery cell system is that such a battery cell system can be made very flexible. The pouch film with the contiguous pockets can be folded in a wide variety of ways, with the result that the shape of the battery cell system and therefore also the means of forming contact with the individual pouch cells can be configured individually, for example with respect to space requirements, the size, folding techniques and contact-forming possibilities. In addition it is advantageous that the battery cell system does not have a limit as far as the stacking height is concerned. It is possible, for example, to stack a plurality of battery cell systems one on top of the other, or at least one battery cell system is folded in such a way that the contiguous pouch cells are present arranged one on top of the other. Furthermore, the proposed battery cell system is flexible with respect to the cell chemistry which is used. It is possible to use, for example, a solid state cell system, for example with a solid as the electrolyte. Alternatively, a liquid electrolyte is used. It is also advantageous that the electrode assemblies which are introduced into the pockets of the pouch film can swell up owing to the flexible pouch film surrounding them, for example as a result of processes of the accumulation and release of the lithium ions or owing to aging. This prevents displacements and damage to the electrode assemblies owing to a large pressure acting on them.

Furthermore, with the battery according to the invention with a pouch film it is advantageous that the pouch film is very flexible, as a result of which the structure with the contiguous pockets can be manufactured very easily, since the pouch film can be bent, folded over, heated and sealed without being damaged, and is flexible, elastic and foldable even after manufacture. Costs are also saved, since the production of the pouch film can take place continuously on one piece, which requires little expenditure in terms of work and is very effective in terms of time. Furthermore, the material costs of a pouch film are very low, for example in comparison with other encapsulations or housings of electrode assemblies such as, for example, prismatic hard shell housings.

In one advantageous embodiment, the at least one battery cell system is arranged on the anisotropic heat distributor. It is advantageous here that many battery cells, or all the battery cells, of the battery cell system bear against the heat distributor and the heat of one or more battery cells during operation, or the heat of an exothermally reacting battery cell in the event of fault, can therefore be distributed to the battery cells of the battery cell system.

In a further advantageous embodiment, the battery has at least two battery cell systems which are arranged on each side of the anisotropic heat distributor. It is advantageous here that the heat of one or more battery cells of a first battery cell system can be additionally distributed to battery cells of a second battery cell system via the heat distributor, as a result of which the individual battery cells of the battery cell systems each have to absorb less thermal energy.

In a further embodiment, a cooling plate is arranged parallel to the at least one heat distributor, so that the cooling plate and the heat distributor are, in particular, not in contact. It is advantageous here that the heat distributor distributes the heat to battery cells which are arranged on one side or on both sides of said heat distributor. The heat which passes via the heat distributor to the battery cells which adjoin the cooling plate can be dissipated to the cooling plate via said battery cells. As a result of the fact that the heat distributor and the cooling plate are arranged parallel to one another, there is, for example, no large temperature gradient compared to batteries whose heat distributors are connected at one end directly to the cooling plate.

Furthermore, the battery according to the invention is used in an electric vehicle, in a hybrid vehicle or in a plug-in hybrid vehicle. Alternatively, the battery is applied, for example, in ships, two-wheeled vehicles, aircraft, stationary energy storage systems, electric tools, entertainment electronics and/or domestic appliances.

### BRIEF DESCRIPTION OF THE DRAWINGS

Embodiments of the present invention are illustrated in the drawing and explained in more detail in the following description of the figures. In the drawing:

FIG. 1a) shows a schematic illustration of a cross section through a battery according to the prior art,

FIG. 1b) shows a schematic illustration of the battery according to FIG. 1a in the case of thermal runaway of a battery cell of the battery,

FIG. 2a) shows a schematic illustration of a cross section through a battery according to the invention with a heat distributor,

FIG. 2b) shows a schematic illustration of the battery according to FIG. 2a in the case of a thermal runaway of a battery cell of the battery, and

FIG. 3 shows a schematic illustration of a 3D view of a battery cell system of a battery according to the invention with a pouch film and electrode assemblies.

### DETAILED DESCRIPTION

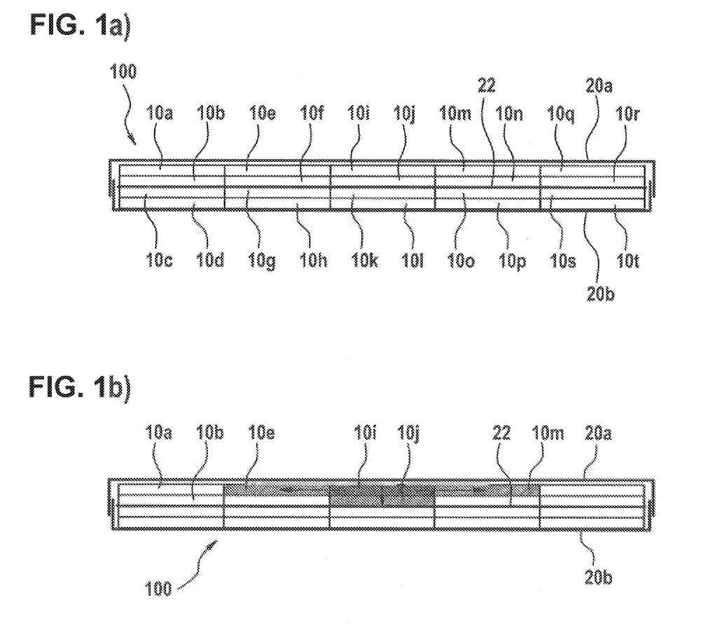

FIG. 1a discloses a battery 100 according to the prior art. The battery 100 has a battery casing which has a first battery casing half 20a and a second battery casing half 20b. The battery 100 has twenty battery cells 10a-t which stand by way of example for any desired number of battery cells 10. Furthermore, the battery 100 has a cooling plate 22. The cooling plate 22 is arranged centrally between the battery cells 10 and serves to dissipate the heat transmitted from the battery cells 10a-t to the cooling plate 22.

FIG. 1b shows the battery 100 according to FIG. 1a in the case of a thermal runaway of the battery cell 10i. The battery cell 10i has overheated and become unusable owing to an exothermal generation of heat. The heat of the battery cell 10i also propagates to the direct adjacent cells 10e, 10m and 10j via their adjoining battery cell houses. The battery cells 10e, 10m and 10j become ever hotter, and likewise generate an upper exothermal formation of heat and finally become unusable owing to overheating. This entrains a chain reaction which is then virtually unstoppable and usually results in a fire and/or explosion.

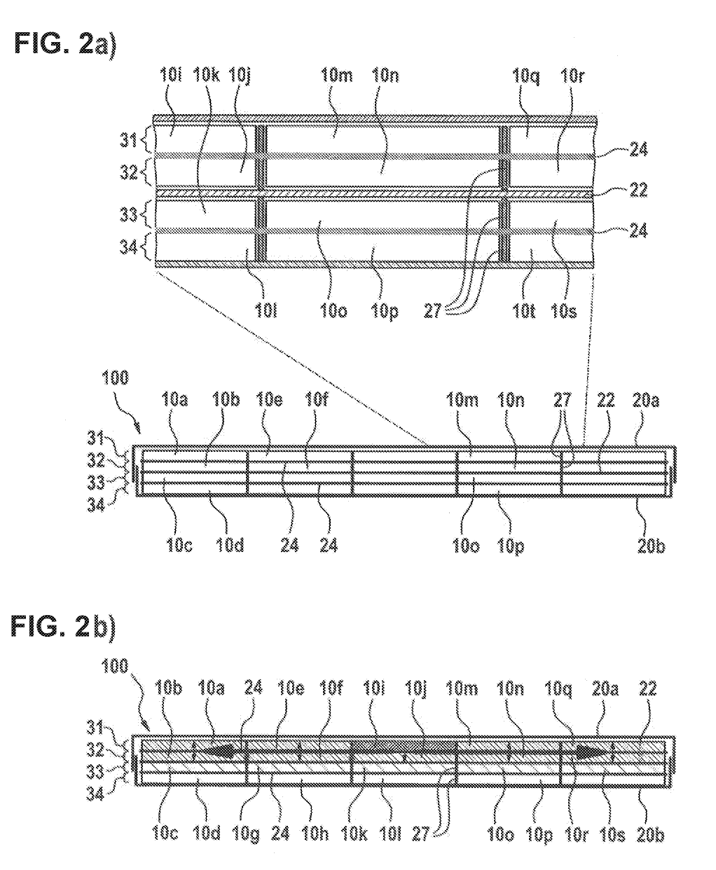

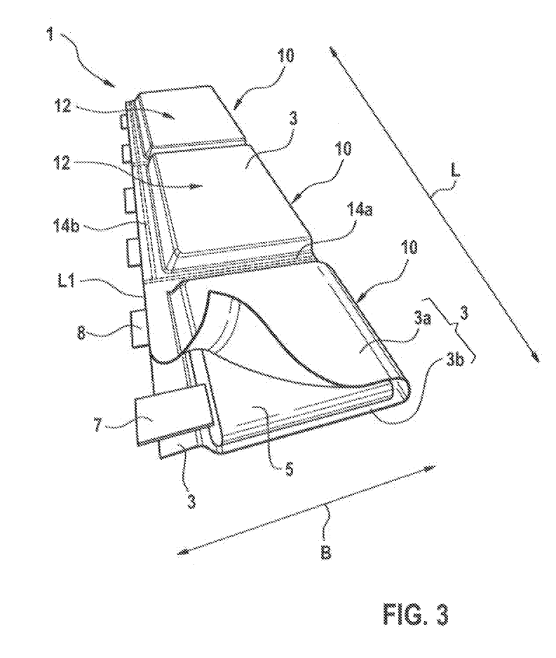

FIG. 2a discloses a battery 100 according to the invention. In contrast to the battery 100 illustrated in FIG. 1a, the battery 100 according to the invention comprises an anisotropic heat distributor 24 between battery cell layers 31-34. A battery cell layer 31-34 comprises all the battery cells 10 which lie one next to the other in a plane. In FIG. 2a, an anisotropic heat distributor 24 is arranged between the battery cell layers 31 and 32 and between battery cell layers 33 and 34. The anisotropic heat distributor 24 is, for example, a graphite film or a heat pipe. A cooling plate 22 is arranged between the battery cell layers 32 and 33. A thermal insulator 27 is respectively introduced between the battery cells 10 of a battery cell layer 31-34. The thermal insulator 27 adjoins the battery cell housings of the respective battery cells 10a-10t on both sides. The thermal insulator 27 prevents a direct transfer of heat from a battery cell 10 to an adjacently arranged battery cell 10 of the same battery cell layer 31-34. The thermal insulator 27 is embodied, for example, as a film. The thermal insulator 27 comprises, for example, a polyurethane, a polystyrene, expanded perlite, a cellular glass, calcium silicate, mica, mineral wool and/or a mineral paper. The thermal insulator 27 has, for example, a thickness of 1-10 mm, in particular of 3-5 mm. The arrangement illustrated in FIG. 2a is merely exemplary. An anisotropic heat distributor 24 can be arranged between every battery cell layer 31-34 or, for example, between every second or every n-th battery cell layer. In an advantageous embodiment (not illustrated), a heat distributor 24 is arranged directly on the cooling plate 22, in particular on both sides of the cooling plate 22. The battery cells 10a-10t are, for example, prismatic battery cells 10a-t with a fixed battery cell housing. In an alternative embodiment, the battery cells 10a-t are pouch cells. In one variant of the alternative embodiment with pouch cells, the pouch cells are organized in a battery cell system 1. This is described in FIG. 3.

FIG. 2b illustrates the battery 100 according to FIG. 2a in the case of a thermal runaway of the battery cell 10i. The battery cell 10i has overheated owing to an exothermal generation of heat. The battery cell 10i directly adjoins the anisotropic heat distributor 24, with the result that the heat which is produced is output directly to the anisotropic heat distributor 24. The latter quickly conducts the heat in the plane and distributes the heat onto the battery cells 10j, e, f, m, n, a, b, q and r which directly adjoin the heat distributor 24, with the result that they heat up somewhat. However, the absorption of heat is so low that the corresponding battery cells 10j, e, f, m, n, a, b, q and r do not experience any damage and can continue to be operated normally. In addition, the battery cells 10b, f, j, n and r output heat to the cooling plate 22, which in turn outputs a part of the heat to the battery cells 10c, g, k, o and s which are arranged on the other side of the cooling plate 22 and then likewise heat up to a small extent. The battery cells 10e and 10m which adjoin the battery cell 10i directly in the battery cell layer 31 are not heated directly by the heat which is released by the battery cell 10i since a transfer of heat from the thermal insulator 27 arranged between the battery cell housings is prevented. With the battery 100 according to the invention it is therefore possible to prevent a chain reaction of battery cells 10a-t which are experiencing thermal runaway.

FIG. 3 illustrates a battery cell system 1 of a battery 100. The battery cell system 1 has a pouch film 3 and three electrode assemblies 5. The three electrode assemblies 5 stand by way of example for any desired number of electrode assemblies 5.

The pouch film 3 has a length L and a width B, wherein the length L is longer than the width B. The pouch film 3 forms pockets 12 which are separated from one another and are connected to one another in a foldable fashion. The pouch film 3 is impermeable to electrolytes.

Each electrode assembly 5 has an anode with an anode contact lug 7, a separator and a cathode with a cathode contact lug 8 which are present stacked one on top of the other. In an alternative embodiment (not illustrated), an electrode assembly 5 has a plurality of anodes and/or anode contact lugs 7 and a plurality of cathodes and/or cathode contact lugs 8. An electrode assembly 5 is introduced into each pocket 12 of the pouch film 3 in such a way that the anode contact lug 7 and the cathode contact lug 8 protrude offset with respect to one another over a first side length L of the pouch film 3.

In each case a battery cell 10 is formed by an electrode assembly 5 together with a pocket 12 of the pouch film 3.

The pouch film 3 comprises, for example, a laminate comprising at least one plastic, in particular a polyolefin such as for example a polyethylene and/or a polypropylene. In one embodiment, the pouch film 3 does not comprise any aluminum, in particular does not comprise any metal.

The pouch film 3 is folded over along the longitudinal extent with the result that a first pouch film half 3a and a second pouch film half 3b are present. Transverse seams 14a, which form pockets 12 which are spatially separated from one another, are introduced into the pouch film halves 3a, 3b along the width B at, in particular, regular intervals. The transverse seams 14a are provided, for example, by sealing the two pouch film halves 3a, 3b to one another. The pockets 12 of the pouch film 3 are closed off along the length L by a longitudinal seam 14b which is formed, for example, sealing the pouch film halves 3a, 3b at their open ends. In this context, the anode contact lugs 7 and the cathode contact lugs 8 are also sealed together in a region in which they bear against the pouch film halves 3a, 3b.

For example an electrolyte, in particular a liquid electrolyte, is introduced into the pockets 12 of the pouch film 3, wherein the pockets 12 form a barrier for the electrolytes.

In FIG. 2a, the battery cell layers 31-34 are, for example, each composed of a battery cell system 1 according to FIG. 3, with the result that each battery cell system 1 corresponds to a battery cell layer 31-34.

1. A battery (100) having at least two battery cells (10a-t) and having at least one anisotropic heat distributor (24), characterized in that the at least two battery cells (10a-t) are arranged adjacent to one another in a plane on the same side of the anisotropic heat distributor (24), in direct thermally conductive contact therewith.

2. The battery (100) according to claim 1, characterized in that the anisotropic heat distributor (24) is a heat pipe or a graphite film.

3. The battery (100) according to claim 1, characterized in that a thermal insulator (27) is introduced between adjoining cell housing faces of adjacent battery cells (10a-t), wherein the thermal insulator (27) prevents a transfer of heat between the adjoining cell housing faces of the adjacent battery cells (10a-t).

4. The battery (100) according to claim 3, characterized in that the material of the thermal insulator (27) comprises a polyurethane, a polystyrene, expanded perlite, a cellular glass, calcium silicate, mica, mineral wool, a mineral paper and/or mineral fibers.

5. The battery (100) according to claim 3, characterized in that the thermal insulator (27) has a thickness of 1-10 mm.

6. The battery (100) according to claim 1, having at least one battery cell system (1) comprising a pouch film (3) with at least two pockets (12) and at least two electrode assemblies (5), characterized in that the electrode assemblies (5) are introduced into the separate pockets (12) of the pouch film (3), with the result that in each case one electrode assembly (5) together with a pocket (12) of the pouch film (3) forms one battery cell (10), wherein the battery cells (10) are physically connected to one another in a foldable fashion by the pouch film (3).

7. The battery (100) according to claim 6, characterized in that the at least one battery cell system (1) is arranged on the anisotropic heat distributor (24).

8. The battery (100) according to claim 6, characterized in that the battery (100) has at least two battery cell systems (1) which are arranged on each side of the anisotropic heat distributor (24).

9. The battery (100) according to claim 1, characterized in that a cooling plate (22) is arranged parallel to the at least one anisotropic heat distributor (24).

10. The battery (100) according to claim 1, wherein the battery is a lithium ion battery.

11. The battery (100) according to claim 3, characterized in that the thermal insulator (27) has a thickness of 3-5 mm.

12. A vehicle comprising a battery (100) according to claim 1.

13. The vehicle according to claim 12 wherein the vehicle is an electric vehicle, a hybrid vehicle or a plug-in hybrid vehicle.
